(19) United States
(12) Patent Application Publication
(10) Pub. No.: US 2016/0248995 A1
(43) Pub. Date: Aug. 25, 2016

(54) SYSTEM AND METHOD FOR USING MILLIMETER WAVE IN A WEARABLE DEVICE

(71) Applicant: DAQRI, LLC, Los Angeles, CA (US)

(72) Inventors: Brian Mullins, Sierra Madre, CA (US); Matthew Kammerait, West Hollywood, CA (US)

(21) Appl. No.: 15/047,818

(22) Filed: Feb. 19, 2016

Related U.S. Application Data
(60) Provisional application No. 62/118,337, filed on Feb. 19, 2015.

(51) Int. Cl. H04N 5/33; G06K 9/00; G06T 11/60; H04N 7/18

(52) U.S. Cl. CPC H04N 5/332; H04N 7/181; G06K 9/00671; G06T 11/60

(57) ABSTRACT

A head mounted device includes different types of sensors for obtaining sensor data of objects in a physical environment near the head mounted device. The sensors include millimeter wave sensors disposed with the head mounted device that are automatically or manually engageable. The millimeter wave sensors may be automatically engaged based on the location of the head mounted device or when the head mounted device receives sensor data indicating an abnormality. The millimeter wave sensors may further be manually engaged based on an instruction received from a user of the head mounted device via an input device, such as a wearable device, or audio command, such as a command received from a microphone coupled with the head mounted device. The millimeter wave sensors provide millimeter wave sensor data that the head mounted device uses to construct millimeter wave sensor images.

### CROSS-REFERENCE TO RELATED APPLICATIONS

This application claims the benefit of priority to U.S. Pat. App. No. 62/118,337, titled “SYSTEM AND METHOD FOR USING MILLIMETER WAVE IN A WEARABLE DEVICE,” and filed Feb. 19, 2015, the disclosure of which is hereby incorporated by reference herein in its entirety.

### TECHNICAL FIELD

The subject matter disclosed herein generally relates to a wearable device. Specifically, the present disclosure describes a head mounted device configured with multiple types of sensors, including one or more millimeter wave sensors.

### BACKGROUND

Augmented reality (AR) is a live direct or indirect view of a physical, real-world environment whose elements are augmented (or supplemented) by computer-generated sensory input such as sound, video, graphics or GPS data. With the help of advanced AR technology (e.g., adding computer vision and object recognition) the information about the surrounding real world of the user becomes interactive. Device-generated (e.g., artificial) information about the environment and its objects can be overlaid on the real world.

Extremely high frequency (EHF) is the ITU designation for the band of radio frequencies in the electromagnetic spectrum from 30 to 300 gigahertz, above which electromagnetic radiation is considered to be low (or far) infrared light, also referred to as terahertz radiation. Radio waves in this band have wavelengths from ten to one millimeter, giving it the name millimeter band or millimeter wave, sometimes abbreviated MMW or mmW. Typical applications of MMW technology include scientific research, telecommunications, weapons systems, and medical treatment.

### BRIEF DESCRIPTION OF THE DRAWINGS

Some embodiments are illustrated by way of example and not limitation in the figures of the accompanying drawings.

FIG. 1 is a block diagram illustrating an example of a network suitable for a head mounted device system, according to some example embodiments.

FIG. 2 illustrates a head mounted device, according to an example embodiment, having millimeter wave sensors disposed therein.

FIG. 3A-3B illustrate the shape of the beams emitted by the millimeter wave sensors of FIG. 2, according to example embodiments.

FIG. 4 is a block diagram of the components of a head mounted device, according to an example embodiment.

FIG. 5 is an interaction diagram illustrating interactions between the components of the head mounted device, according to an example embodiment.

FIG. 6 is another interaction diagram illustrating another example of an interaction between the components of the head mounted device, according to an example embodiment.

FIG. 7 is a further interaction diagram illustrating interactions between the head mounted device and a sensor data processing server, according to an example embodiment.

FIGS. 8A-8B illustrate a method for obtaining sensor data using the millimeter wave sensors of the head mounted device of FIG. 2, according to an example embodiment.

FIG. 9 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to a head mounted device (HMD) having different types of sensors, including millimeter wave (MMW) sensors, for capturing different types of image data. In one example embodiment, the HMD includes a helmet with a retractable display having a display surface disposed thereon. The retractable display may be adjustable such that the display surface is presentable at eye-level to the wearer of the HMD. The display surface includes a display lens configured to display augmented reality (AR) content. The HMD may include local and/or remote processing capabilities that allows the wearer of the to experience information, such as in the form of a virtual two- or three-dimensional object, apparently overlaid on a physical object in a physical environment viewed through the retractable display.

The HMD includes different types of sensors to provide information about a physical object or about the real-world environment surrounding or near the physical object. The physical object may include a visual reference (e.g., a recognized image, pattern, or object, or unknown objects) that an AR display module can identify using predefined objects or machine vision. A visualization of the AR information (also referred to as AR content) is generated in the display lens of the HMD. The display lens may be transparent to allow the user see through the display lens. The display lens may be part of a visor or face shield of the HMD or may operate independently from an attached visor.

The virtual objects shown on the display may be selected from a database of virtual objects based on the recognized visual reference or captured image of a corresponding physical object. A rendering of the visualization of the virtual object may be based on a position of the display relative to the visual reference. Other AR applications may allow the user to experience visualization of the additional information overlaid on top of a view or an image of any object in the real physical world. The virtual object may include one or more of a three-dimensional virtual object, a two-dimensional virtual object, or combinations thereof. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu, etc.) may be rendered at the helmet or at a server in communication with the helmet. In one example embodiment, the user of the helmet may navigate the AR content using audio and visual inputs captured at the helmet, or other inputs from other devices, such as a wearable device. For example, the display lenses may extract or retract based on a voice command of the user, a gesture of the user, a position of a watch in communication with the helmet.

In another example embodiment, anon-transitory machine-readable storage device may store a set of instructions that, when executed by at least one processor, causes the at least one processor to perform the method operations discussed within the present disclosure.

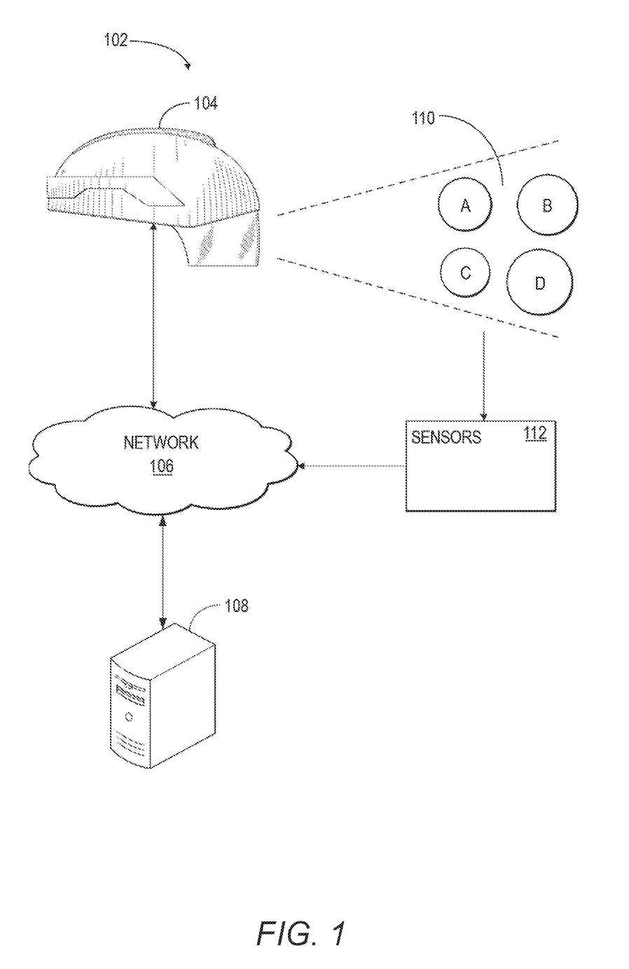

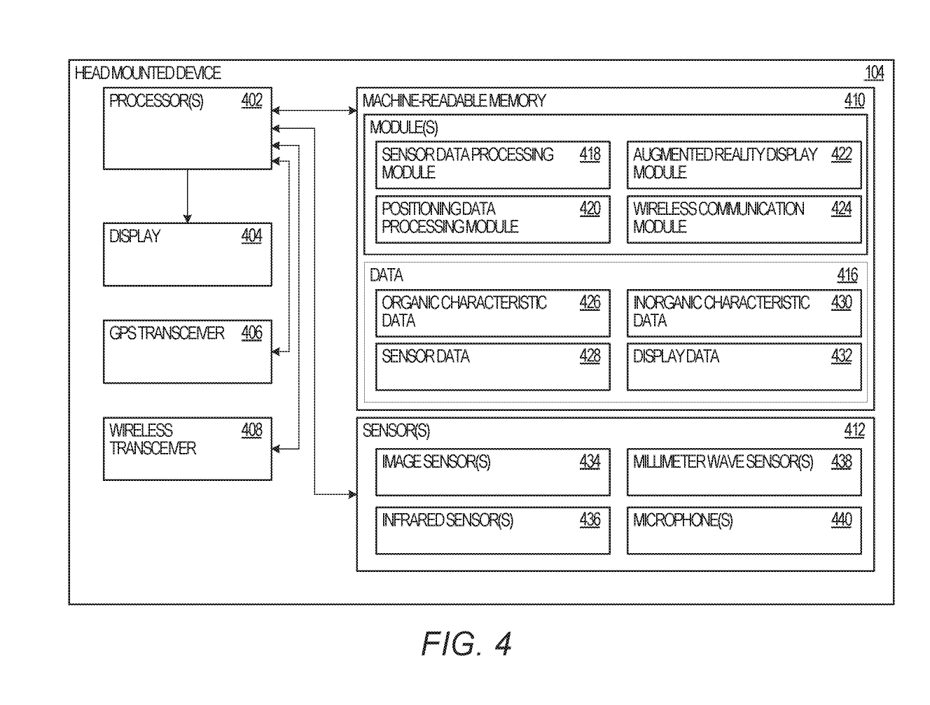

FIG. 1 is a network diagram illustrating a network environment 102 suitable for operating an AR application of an HMD 104 having millimeter wave sensors according to an example embodiment. The network environment 102 includes an HMD 104 in communication with a sensor data processing server 108 via a network 106. The HMD 104 and the sensor data processing server 108 may each be implemented in a computer system, in whole or in part, as described below with reference to FIG. 4. The network environment 102 further includes external sensors 112 communicatively coupled to the HMD 104 and the sensor data processing server 108. The sensors 112 are configured to receive sensor data from one or more of the objects the physical environment 110.

The server 108 may be part of a network-based system. For example, the network-based system may be, or include, a cloud-based server system that provides AR content (e.g., augmented information including 3D models of virtual objects related to physical objects captured by the HMD 104) to the HMD 104.

The network 106 may include one or more types of networks communicatively coupled to the HMD 104 and the sensor data processing server 108. As examples, the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The HMD 104 may include a helmet that a user wears to view the AR content related to captured images of several physical objects (e.g., object A, object B, object C, object D, etc.) in a real world physical environment 110. In one example embodiment, the HMD 104 includes a computing device communicatively coupled to various types of sensors and a display (e.g., smart glasses, smart helmet, smart visor, smart face shield, smart contact lenses). The computing device may be removably mounted to the head of the user. In one example, the display may be a screen that displays images captured by the one or more sensors of the HMD 104. In another example, the display of the HMD 104 may be transparent or semi-transparent surface, such as in a visor or face shield of a helmet, or a display lens distinct from the visor or face shield of the helmet.

The physical environment 110 may include identifiable objects such as a 2D physical object (e.g., a picture), a 3D physical object (e.g., a factory machine), a location (e.g., at the bottom floor of a factory), or any references (e.g., perceived corners of walls or furniture) in the physical environment 110. The AR display module may include computer vision recognition to determine corners, objects, lines, and letters. The user of the HMD 104 may direct a camera of the HMD 104 to capture an image of the objects in the physical environment 110.

In one example embodiment, objects in the physical environment 110 are tracked and recognized locally in the HMD 104 using local characteristic data for organic and/or inorganic objects. In another embodiment, the Objects in the physical environment 110 are tracked and recognized remotely at the sensor data processing server 108 using remote characteristic data for organic and/or inorganic objects. The characteristic data, whether stored locally or remotely, may include a library of virtual objects or augmented information associated with real-world physical objects or references.

The user of the HMD 104 may be a user of an AR application in the HMD 104 and at the sensor data processing server 108. More particularly, the user may be a human user e.g., a human being), a machine user (e.g., a computer configured by a software program to interact with the HMD 101), or any suitable combination thereof (e.g., a human assisted by a machine or a machine supervised by a human). The user is not part of the network environment 102, hut is associated with the HMD 104. The AR display module may provide the user with an AR experience triggered by one or more conditions satisfied based on sensor data obtained by one or more sensors of the HMD 104. Such conditions may include the recognition of a particular object, the location of the HMD 104 relative to another object or location, the detection of an event (e.g., loud noises, sudden increases in temperature, etc.), and other such conditions or combinations.

As discussed below with reference to FIG. 4 the HMD 104 includes various types of sensors to detect objects and/or environmental conditions in the real-world environment 110. Such sensors may include image sensors, infrared sensors, microphones, temperature sensors, and other such sensors. Further still, the sensors include millimeter wave sensors, which the HMD 104 may use to inform the user of a potential threat or by the user of the HMD 104 to view sub-surface objects.

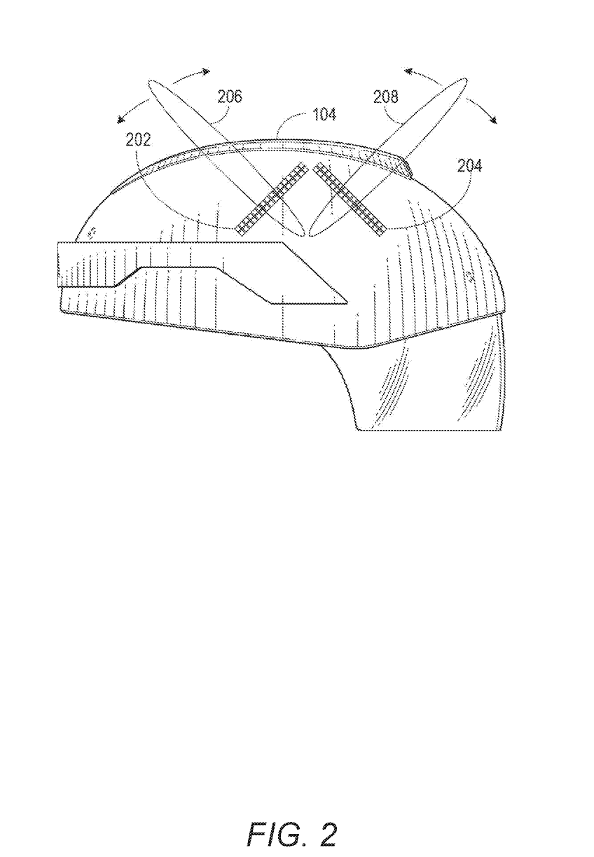

FIG. 2 illustrates the head mounted device 104, according to an example embodiment, having millimeter wave sensors 202-204 disposed therein, one embodiment, the millimeter wave sensors 202-204 are each an active electronically scanned array of sensors with steerable antenna beams. The millimeter wave sensors 202-204 are configured to emit RF energy in the W-band, which ranges from 75 to 110 GHz, because it offers improved spatial resolution in a small aperture. More particularly, and in one embodiment, the millimeter wave sensors 202-204 emit RF energy at 94 GHz and have a wavelength of 3.19 mm. One example of millimeter wave sensors that may be included in the HMD 104 are the sensors available from Sago Systems, Inc., which is located in San Diego, Calif.

The sensors 202-204 each generate an independently steerable beam (e.g., beams 206-208) that orthogonally scan the surroundings of the FIND 104. The beams 206-208 provide a wide field-of-view in one dimension (e.g., when parallel to the millimeter wave sensors 202-204) and a narrow field-of-view in another dimension (e.g., when the beams 206-208 are orthogonal to the millimeter wave sensors 202-204). Although two sensors are illustrated in FIG. 2, the HMD 104 may include multiple paired millimeter wave sensors to create a 360° field-of-view around the HMD 104.

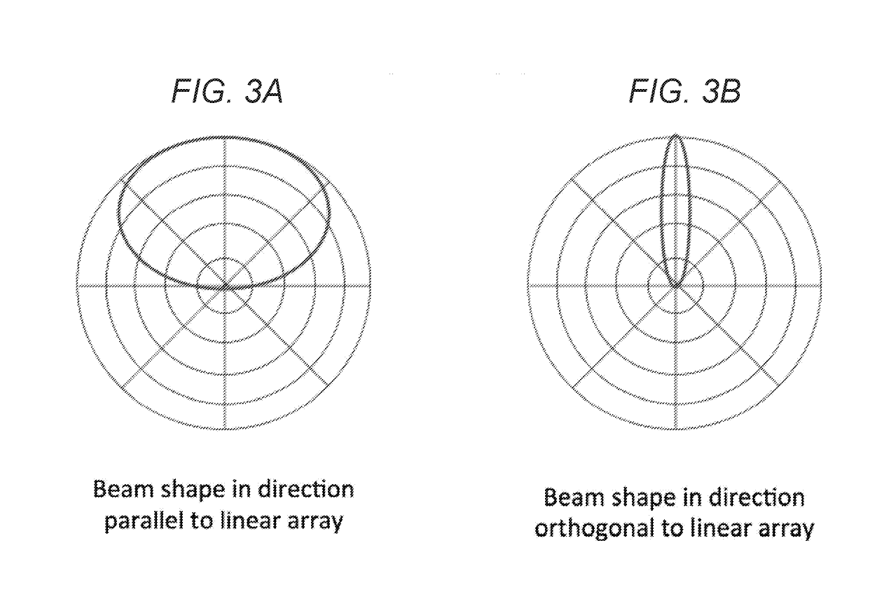

FIGS. 3A-3B illustrate the beam shape of the beams 206-208 shown in FIG. 2 depending on whether a given beam is parallel or orthogonal to a given millimeter wave sensor. FIG. 3A illustrate the shape of a beam when the beam is emitted in a direction parallel to a given millimeter wave sensor. FIG. 3B illustrates the shape of a beam when the beam is emitted in a direction orthogonal to a given millimeter wave sensor.

FIG. 4 is a block diagram of the components of the HMD 104 according to an example embodiment. In one embodiment, the HMD 104 includes one or more processors 402, a display 404, a GPS transceiver 406, a wireless transceiver 408, a machine-readable memory 410, and one or more sensors 412.

The processor(s) 402 may be a general-purpose processor configurable by software to become a special-purpose processor. Further still, the processor(s) 402 may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Examples of processor(s) 402 include those processors commercially available from such companies as Intel, Qualcomm, Texas Instruments, or AMD.

The display 404 may include a display surface or lens configured to display AR content (e.g., images, video) generated by the processor(s) 402. In another embodiment, the display 404 may also include a touchscreen display configured to receive a user input via a contact on the touchscreen display. In another example, the display 404 may be transparent or semi-transparent so that the user can see through a display lens (e.g., such as in a Head-Up Display).

The GPS transceiver 406 is configured to communicate with and receive GPS coordinates from the Global Navigation Satellite System. The GPS transceiver 406 is communicatively coupled to the processor(s) 402 such that received GPS coordinates are stored in the memory 410.

The wireless transceiver 408 is configured to communicate wirelessly with one or more devices. The wireless transceiver 408 may include one or more transceivers such as a Bluetooth® transceiver, a Near Field Communication (NFC) transceiver, an 802.11x transceiver, a 3G (e.g., a GSM and/or CDMA) transceiver, a 4G (e.g., LTE and/or Mobile WiMAX) transceiver, or combinations thereof. The wireless transceiver 408 may be configured to communicate with the sensor data processing server 108. In one embodiment, the wireless transceiver 408 communicates the sensor data 428 obtained by one or more of the sensors 412 to the server 108 and, in return, receives the results of the server 108 having processed the obtained sensor data 428. The wireless transceiver 408 may further communicate with other devices, such as a smartphone, another wearable device communicatively coupled to the HMD 104, other HMDs, or any other such device or combinations of devices.

The sensors 412 include one or more image sensors 434, one or more infrared sensors 436, one or more millimeter wave sensors 438 (which also include the millimeter wave sensors 202-204 illustrated in FIG. 2), and one or more microphones 440. The sensors 412 may further include other sensors not specifically illustrated, such as one or more orientation sensor(s) (e.g., gyroscope, or an inertial motion sensor), an audio sensor (e.g., a microphone), or any suitable combination thereof. The image sensor(s) 434 may include one or more combinations of CCD and/or CMOS cameras configured to capture images of the physical environment. In one embodiment, the image sensor(s) 434 include a rear facing camera(s) and a front facing camera(s) disposed in the HMD 104.

It is noted that the sensors 412 described herein are for illustration purposes. Sensors 412 are thus not limited to the ones described. The sensors 412 may be used to generate internal tracking data of the HMD 104 to determine what the HMD 104 is capturing or looking at in the real physical world. For example, a virtual menu may be activated when the sensors 412 indicate that the HMD 104 is oriented downward (e.g., when the user tilts his head to watch his wrist).

The millimeter wave sensor(s) 438 may be engageable based on sensor data 428 obtained from one or more of the other sensor(s) 412. In one embodiment, the data 416 stores one or more conditional contexts which, when satisfied, cause the processor(s) 402 to engage the millimeter wave sensor(s) 438. For example, where the sensor data 428 from the image sensor(s) 434 indicate a person of interest is nearby (e.g., through facial recognition), the millimeter wave sensor(s) 438 are engaged to determine whether the person of interest is concealing any objects underneath his or her clothing. In this embodiment, the HMD 104 communicates sensor data 428 to the sensor data processing server 108, which provides the HMD 104 with indications of whether a person of interest is within the field of view of the HMD 104. The sensor data processing server 108 may provide such information as GPS coordinates that indicate the person of interest and/or two-dimensional image coordinates of where the person of interest appears in the one or more image(s) recorded by the one or more senor(s) 412. Additionally, and/or alternatively, the HMD 104 may perform the facial recognition of the obtained sensor data 428 using one or more modules 414, such as the sensor data processing module 418, executable by the one or more processor(s) 402. Using the sensor data 428 obtained from the sensor data processing server 108 and/or the sensor data processing module 418, the HMD 104 then engages the millimeter wave sensor(s) 438 and directs such sensor(s) 438 towards the identified person of interest (e.g., by rotating and/or orienting the beam emitted from the sensor(s) 438 relative to the sensor array).

As another example, where the infrared sensor(s) 436 indicate that a region or object is particularly hot or cold (or abnormally hot or cold), the millimeter wave sensor(s) 438 are engaged to determine whether a sub-surface object is causing the region or object to be excessively hot or cold. In one embodiment, the HMD 104 communicates the sensor data 428 obtained by the infrared sensors 436 to the sensor data processing server 108. In return, the sensor data processing server 108 indicates whether the temperatures of objects corresponding to the sensor data 428 have exceeded a high temperature threshold or have fallen below a low temperature threshold. Alternatively or additionally, such comparison may be performed by the sensor data processing module 418. As discussed above, in response to the analyzed sensor data 428, the HMD 104 engages the millimeter wave sensor(s) 438 and directs such sensor(s) 438 towards the object or objects having the high or low temperature.

Further still, the millimeter wave sensor(s) 438 are manually engageable such that the millimeter wave sensor(s) 438 are engaged upon request by the user (or remote operator) of the HMD 104. For example, the user of the HIM 104 may use a graphical user interface (or other interface) to engage the sensor(s) 438.

The memory 410 includes one or more modules 414 that provide an augmented reality to the wearer of the HMD 104 and various types of data 416 to support the modules 414. In one embodiment, the modules 414 include a sensor data processing module 418, a positioning data processing module 420, an augmented reality display module 422, and a wireless communication module 424. Also, in one embodiment, the data 416 includes organic characteristic data 426, sensor data 428, inorganic characteristic data 430, and display data 432.

In one embodiment, the sensor data processing module 418 processes the sensor data 428 obtained by the various sensor(s) 412. Processing the sensor data 428 may include comparing the obtained sensor data 428 with previously stored characteristic data 426,430, constructing images obtained from the sensor data 428 (e.g., thermographic images derived from infrared data obtained by the infrared sensor(s) 436), normalizing the obtained sensor data 428, and other such processing techniques. The positioning data processing module 420 processes the UPS positioning data obtained by the GPS transceiver 406, which may include comparing the obtained GPS positioning data with previously stored GPS positioning data and/or storing the obtained GPS positioning data in the memory 410 for later retrieval. The augmented reality display module 422 is configured to provide a visualization on the display 404 based on the obtained sensor data. As discussed below, the visualization may be displayed in a manner such that the visualization appears overlaid on objects in the physical environment 110. Finally, the wireless communication module 424 is configured to wirelessly communicate with one or more devices, such as the server 108, via the wireless transceiver 408.

In one embodiment, the data 416 includes data that distinguishes between various types of objects, such as organic and inorganic objects. Accordingly, the data 416 includes organic characteristic data 426 and inorganic characteristic data 430. The organic characteristic data 426 defines various properties of organic objects (e.g., people, animals, insects, food products, etc.) when exposed to millimeter wave RF energy such that one organic object is distinguishable from another organic object. Similarly, the inorganic characteristic data 430 defines various properties of inorganic objects (e.g., minerals, metals, plastics, chemicals, etc.) when exposed to millimeter wave RF energy such that one inorganic object is distinguishable from another inorganic object. In one embodiment, the organic characteristic data 426 and/or the inorganic characteristic data 430 are stored in a lookup table or other array where the rows of the array correspond to objects (e.g., organic and inorganic objects) and the columns of the array correspond to the millimeter wave RF energy responses, such as emissivity, temperature, reflectance, or other such characteristics or combination of characteristics. Further still, by referencing the data 426/430 with the measurements obtained by the millimeter wave sensor(s) 438, the processor(s) 402 can distinguish between organic and inorganic objects. The results of such comparison can be stored as display data 432 and displayed to the user via the augmented reality module 422.

In addition, the organic characteristic data 426 and/or the inorganic characteristic data 430 may include an identifier or label that indicate or identify whether a given object is a potential threat. For example, where the inorganic characteristic data 430 includes metals, such as aluminum, steel, brass, or other such metals, each of the metals may include an identifier that signifies that the metal represents a potential threat. Accordingly, when an inorganic object is identified as being one of the metals listed above, the sensor data processing module 418 may instruct the augmented reality display module 422 to display a prompt, or other message, on the display 404 to alert the user of the HMD 104 that there is a potential threat and the location of such threat (e.g., via the positioning data processing module 420). In this manner, other organic and/or inorganic objects may be labeled in the with the threat identifier that causes this prompt to be displayed to the user of the HMD 104.

Sensor data 428 and/or display data 432 may further include data defining one or more virtual objects associated with real-world physical objects or references. In one example, the HMD 104 identifies feature points in an image of the objects in the physical environment 110 to determine different planes (e.g., edges, corners, surface, dial, letters). The HMD 104 may also identify tracking data related to the objects (e.g., GPS location of the HMD 104, orientation, distances to the objects, etc.). If the captured image is not recognized locally at the HMD 104, the HMD 104 activates the wireless communication module 424 to obtain download information (e.g., 3D model or other augmented data) corresponding to the captured image, from a database of the server 108 via the network 106.

The memory 410 may also store a database of visual references (e.g., images) and corresponding experiences (e.g., 3D virtual objects, interactive features of the 3D virtual objects). The database may include a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 108. The core set of images may include a limited number of images identified by the server 108. For example, the core set of images may include the images depicting covers of the ten most viewed objects and their corresponding experiences (e.g., virtual objects that represent the ten most sensing devices in a factory floor). In another example, the server 108 may generate the first set of images based on the most popular or often scanned images received at the server 108. Thus, the primary content dataset does not depend on objects or images obtained by the HMD 104.

The contextual content dataset includes, for example, a second set of images and corresponding experiences (e.g., three-dimensional virtual object models) retrieved from the server 108. For example, images captured with the HMD 104 that do not include content recognized (e.g., by the server 108) in the primary content dataset are submitted to the server 108 for recognition. If the captured image is recognized by the server 108, a corresponding experience may be downloaded at the HMD 104 and stored in the contextual content dataset. Thus, the contextual content dataset relies on the context in which the FWD 104 has been used. As such, the contextual content dataset depends on objects or images captured by the image sensor(s) 434 and processed by the sensor data processing module 418.

In one embodiment, the HMD 104 may communicate over the network 106 with the server 108 to retrieve a portion of a database of visual references, corresponding 3D virtual objects, and corresponding interactive features of the 3D virtual objects. Accordingly, the HMD 104 may engage the wireless communication module 424 and the wireless transceiver 408 to communicate wirelessly with other machines, such as the server 108 or wearable devices.

The augmented reality display module 422 is configured to generate display of information related to objects in the physical environment 110. In one example embodiment, the AR display module 422 generates a visualization of information related to the objects when the FWD 104 captures an image of the objects and, through one or more image recognition techniques, recognizes the objects. Alternatively, the AR display module 422 generates a visualization of information related to the objects when the HMD 104 is in proximity to the Objects. Proximity to the objects may be determined from GPS positional information obtained by the GPS transceiver 406 and processed by the positioning data processing module 420.

In displaying visualizations on the display 404, the AR display module 422 may generate a display of a holographic or virtual menu visually perceived as a layer on the objects in the physical environment 110. A display controller (not shown) is configured to control the display 404, such as by controlling an adjustable position of the display 404 and/or the power supplied to the display 404.

Referring back to FIG. 1, the HMD 104 may leverage one or more sensors external to the FINED 104 (e.g., sensors 112) to identify or recognize various objects in the physical environment 110. In one embodiment, the sensors 112 may be associated with, coupled to, and/or related to the one or more objects in the physical environment 110 to measure a location, information, or other reading of the objects. Examples of measured reading may include, but are not limited to, weight, pressure, temperature, velocity, direction, position, intrinsic and extrinsic properties, acceleration, and dimensions. For example, the sensors may be disposed throughout a factory floor to measure movement, pressure, orientation, and temperature. The server 108 can compute readings from data generated by the sensors 112.

In one embodiment, the server 108 generates virtual indicators, such as vectors or colors, based on data from sensors 112. The virtual indicators are then received by the wireless communication module 424 and displayed, via the AR display module 422, overlaid on top of a live image of objects in the physical environment 110 to show data related to the Objects. For example, the virtual indicators may include arrows with shapes and colors that change based on real-time data. The visualization may be provided to the 104 so that the HMD 104 can render the virtual indicators in a display of the HMD 104. In another embodiment, the virtual indicators are rendered at the server 108 and streamed (e.g., communicated in real-time or near real-time) to the HMD 104. The HMD 104 displays the virtual indicators or visualization corresponding to a display of the physical environment 110 (e.g., data is visually perceived as displayed adjacent to the objects in the physical environment 110).

The sensors 112 may include other sensors used to track the location, movement, and orientation of the HMD 104 externally without having to rely on the sensors internal to the HMD 104. The sensors 112 may include optical sensors (e.g., depth-enabled 3D camera), wireless sensors (Bluetooth, Wi-Fi), GPS sensor, and audio sensor to determine the location of the user having the HMD 104, distance of the user to the sensors 112 in the physical environment 110 (e.g., sensors placed in corners of a venue or a room), the orientation of the HMD 104 to track what the user is looking at (e.g., direction at which the HMD 104 is pointed).

In another embodiment, data from the sensors 112 and internal sensors in the HMD 104 may be used for analytics data processing at the server 108 (or another server) for analysis on usage and how the user is interacting with the physical environment 110. Live data from other servers may also be used in the analytics data processing. For example, the analytics data may track where on the physical or virtual object (e.g., which points and/or features) the user has looked, how long the user has looked at each point and/or feature, how the user moved with the HMD 104 when looking at the physical or virtual object, which features of the virtual object the user interacted with (e.g., such as whether a user tapped on a link in the virtual object), and any suitable combination thereof. As a result of such interactions, the HMD 104 receives visualization content from the server 108 related to the analytics and/or sensor data. The HMD 104 then generates, via the augmented reality display module 422, a virtual object with additional or visualization features, or a new experience, based on the visualization content dataset.

Any of the machines, databases, or devices discussed above may be implemented in a general-purpose computer modified (e.g., configured or programmed) by software to be a special-purpose computer to perform one or more of the functions described herein for that machine, database, or device. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices described above may be combined into a single machine, and the functions described herein for any single machine, database, or device may be subdivided among multiple machines, databases, or devices.

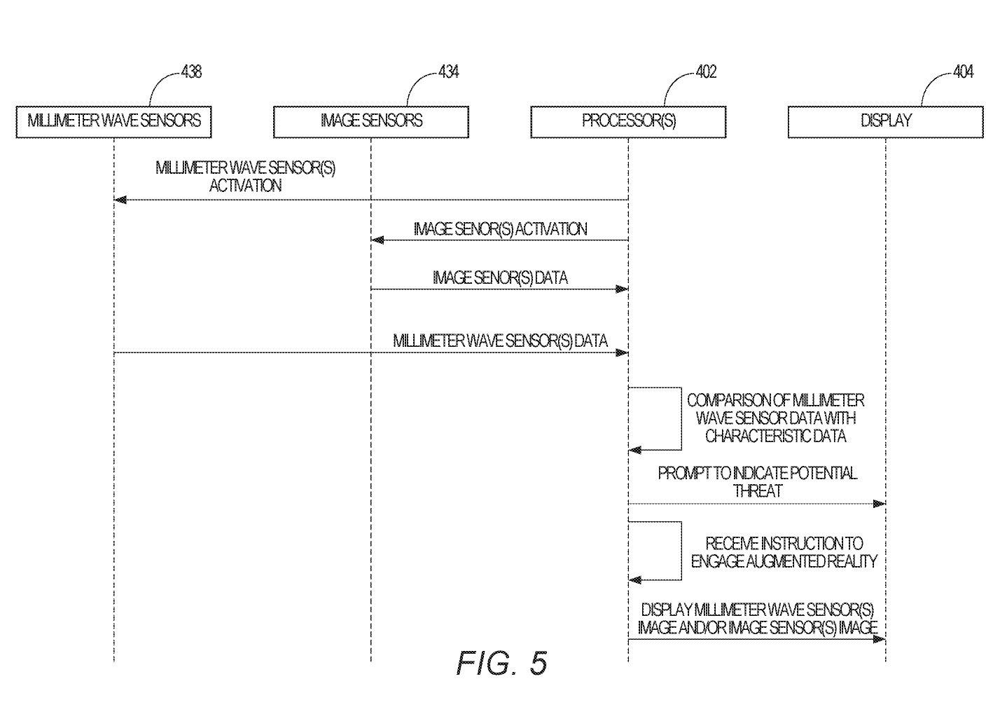

FIG. 5 is an interaction diagram illustrating an example of an interaction between the components of the HMD 104. The interactions include interactions between the processor(s) 402 and the millimeter wave sensor(s) 438, the processor(s) 402 and the image sensor(s) 434, and the processor(s) 402 and the display 404. In particular, FIG. 5 illustrates prompting the user whether the user would like to display a millimeter wave sensor image based on obtained millimeter wave sensor data. In this regard, the millimeter wave sensor data may be compared with the previously stored characteristic data (e.g., the organic characteristic data 426 and/or the inorganic characteristic data 430) to determine whether a prompt should be displayed to the user. While the comparison of the millimeter wave sensor data is used as a feature in deciding whether to prompt the user, the HMD 104 may also use other features, such as comparisons with image sensor data (e.g., image recognition performed on the obtained image sensor data), comparisons with obtained infrared data, comparisons with obtained audio data, or other such features or combinations of features.

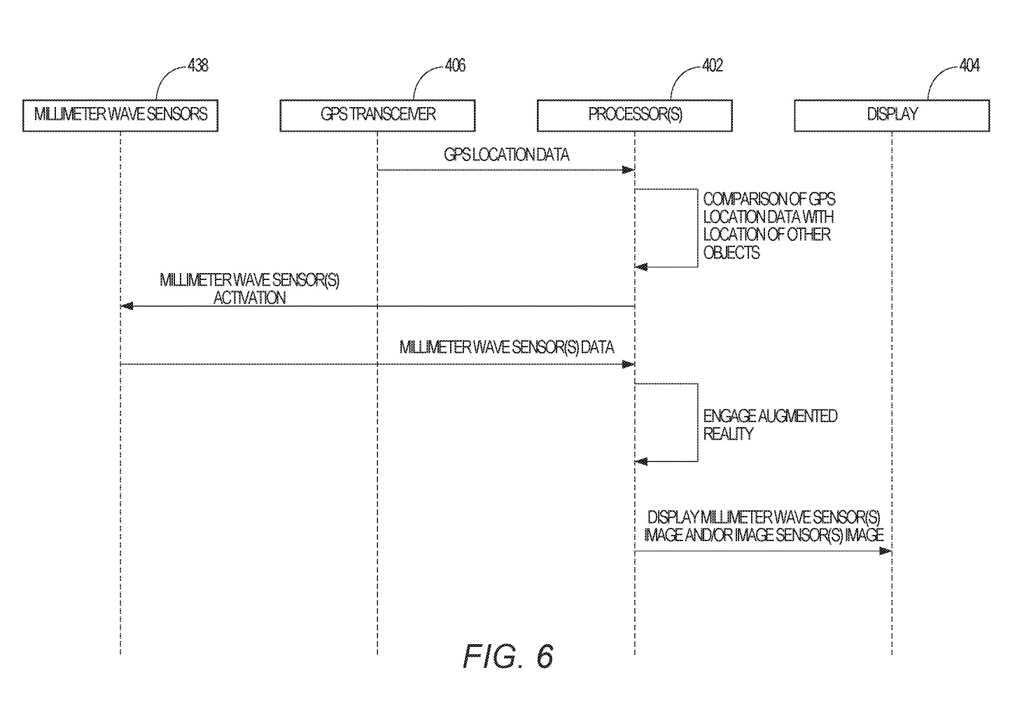

FIG. 6 is another interaction diagram illustrating another example of an interaction between the components of the HMD 104. The interactions include interactions between the processor(s) 402 and the millimeter wave sensor(s) 438, the processor(s) 402 and the GPS transceiver 406, and the processor(s) 402 and the display 404. In particular, FIG. 6 illustrates automatically displaying an image constructed from the millimeter wave sensor data based on a comparison of obtained GPS positional data with previously stored positional data of other objects. As an example, the millimeter wave sensor image may be displayed when the user of the HMD 104 approaches a particular location, such as the edge of a police checkpoint or a specified location of a factory floor. While the obtained GPS positional data is used as a feature in deciding whether automatically display a millimeter wave sensor image, the HMD 104 may also use other features, such as comparisons with image sensor data (e.g., image recognition performed on the obtained image sensor data), comparisons with obtained infrared data, comparisons with obtained audio data, or other such features or combinations of features.

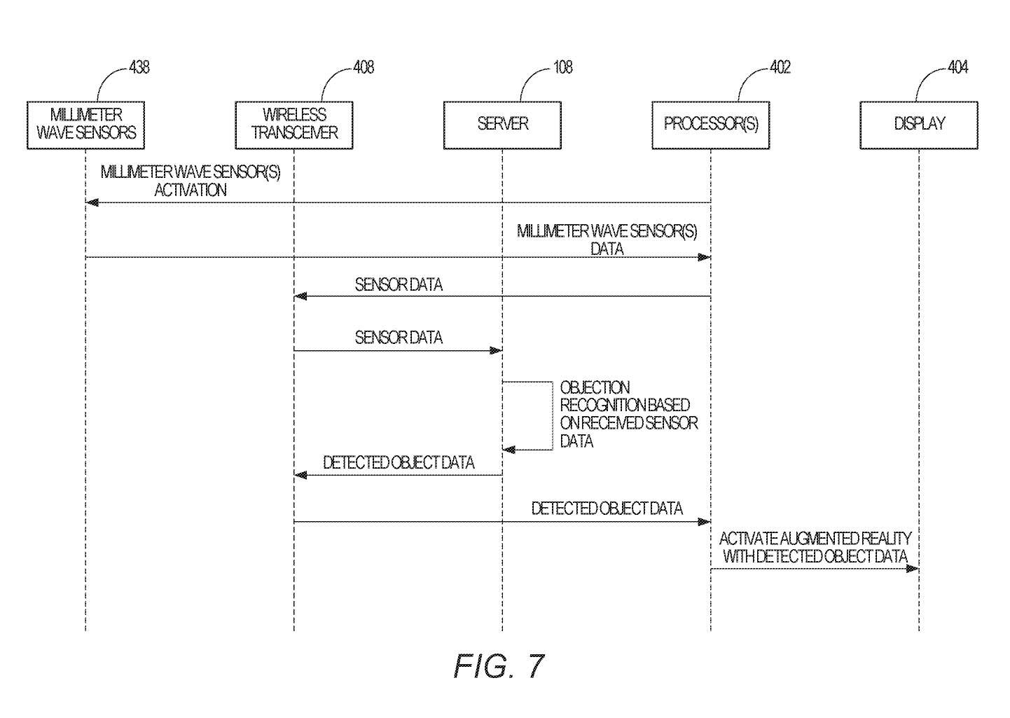

FIG. 7 is a further interaction diagram illustrating an example of an interaction between the HMD 104 and the sensor data processing server 108. In particular, FIG. 7 illustrates that the server 108 can be leveraged to perform object recognition on sensor data obtained by the HMD 104. In the example presented in FIG. 7, the HMD 104 transmits obtained millimeter wave sensor data, along with other sensor data, to the server 108, which then performs object detection and/or recognition on the received sensor data. The server 108 then transmits the detected object data to the HMD 104, which then displays a visualization of the detected object data on the display 404. In this manner, the HMD 104 can leverage the server 108 to perform processing of the sensor data so that the resources of the HMD 104 (e.g., processing cycles, electrical power, etc.) can be used in the collection of sensor data and in the display of the detected object data.

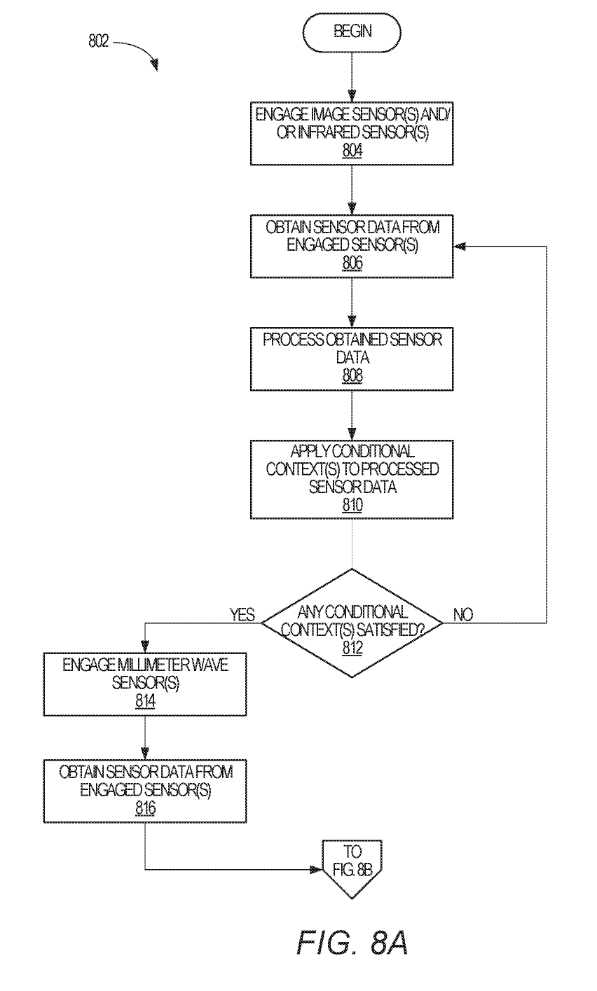

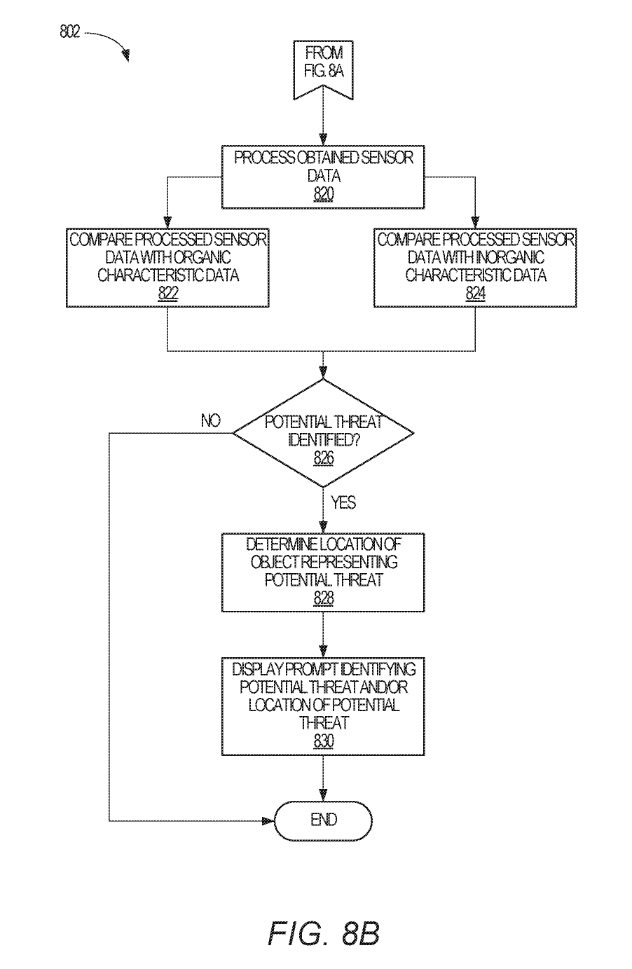

FIGS. 8A-8B illustrate a method 802 for obtaining sensor data 428 using the millimeter wave sensor(s) 438 of the HMD 104 of FIG. 2, according to an example embodiment. The method 802 may be implemented by one or more components of the HMD 104 as illustrated in FIG. 4 and is discussed by way of reference thereto.

Referring to FIG. 8A, the HMD 104 initially engages one or more of the image sensor(s) 434 and/or infrared sensor(s) 436 (Operation 804). The engaged sensors 434-436 then acquire or obtain sensor data 428 from the environment in which the HMD 104 is located (Operation 806). As discussed above, the obtained sensor data 428 is then processed by the sensor data processing server 108 and/or the sensor data processing module 418 of the HMD 104 (Operation 808). In one embodiment, processing the obtained sensor data 428 includes performing image recognition on images obtained by one or more of the image sensor(s) 434 and/or determining temperatures detected by the infrared sensor(s) 436.

The HMD 104 then applies one or more conditional contexts to the processed sensor data 428 (Operation 810). As explained above, the conditional contexts serve as an initial step in determining whether the HMD 104 should engage one or more of its millimeter wave sensor(s) 438. The HMD 104 then determines whether one or more of the conditional contexts are satisfied (Operation 812), if this is determined in the negative (e.g., “NO” branch of Operation 812), the HMD 104 continues acquiring sensor data 428 from the engaged sensors 434-436. However, if one or more the conditional context are satisfied (e.g., “YES” branch of Operation 812), the method 802 proceeds to Operation 814.

At Operation 814, the HMD 104 engages one or more of the millimeter wave sensor(s) 438. In one embodiment, a user is prompted as to whether the HMD 104 should engage the one or more millimeter wave sensor(s) 438. In another embodiment, the HMD 104 automatically engages the millimeter wave sensor(s) 438. As discussed above, the HMD 104 may direct the one or more millimeter wave sensor(s) 438 toward the objects detected in the processed sensor data 428 by moving or directing the beam emitted by the one or more millimeter wave sensor(s) 438. The HMD 104 then obtains sensor data 428 from the engaged one or more millimeter wave sensor(s) 438 (Operation 816). In one embodiment, this may also include activating the augmented reality display module 422 to create an augmented reality display of the environ ent and/or the objects to be scanned by the millimeter wave sensor(s) 438.

Referring to FIG. 8B, the obtained sensor data 428 is then processed by the HMD 104 and/or the sensor data processing server 108 (Operation 820). The HMD 104 then compares the processed sensor data 428 with the stored organic characteristic data 426 (Operation 822) and the stored in organic characteristic data 430 (Operation 824). Alternatively, and/or additionally, the comparison may be performed by the sensor data processing server 108.

Based on the comparison, the HMD 104 then determines whether a potential threat has been identified (Operation 826). As discussed above, one or more materials and/or objects may be associated with potential threats and the comparison of the sensor data with the organic characteristic data and/or the inorganic characteristic data may result in the HMD 104 having identified a potential threat. Where no potential threat has been identified (e.g., “NO” branch of Operation 826), the method 802 may terminate until additional sensor data 420 is obtained. Where potential threat has been identified (e.g., “YES” branch of Operation 828), the HMD 104 then attempts to identify or determine the location of the object representing the potential threat (Operation 828). In one embodiment, the HMD 104 invokes the position data processing module 420 to resolve the location of the potential threat, which may use GPS coordinates or other environmental features to perform this resolution. The HMD 104 may then display a prompt on the display 404 that identifies the potential threat, the type of potential threat (e.g., by cross-referencing the organic characteristic data 426 and/or inorganic characteristic data 430), and location of the potential threat (Operation 830).

In this manner, the HMD 104 leverages a combination of traditional image sensors with millimeter wave technology to provide an augmented reality display that incorporates images obtained using millimeter wave sensors. Such combination can provide a user with imaging information that would ordinarily be difficult to obtain under a variety of environmental conditions, such as fog, smoky conditions, low light conditions, rain, or busy environments airports, traffic intersections, and other such busy environments). Furthermore, as the HMD 104 may be in communication with an off-site sensor data processing server, the HMD 104 can be made relatively lightweight as the sensor data processing server can perform the processing of data that would require additional hardware and cooling resources. However, as processors are made more efficient, the HMD 104 can also be manufactured to support sensor data processing by its own components.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

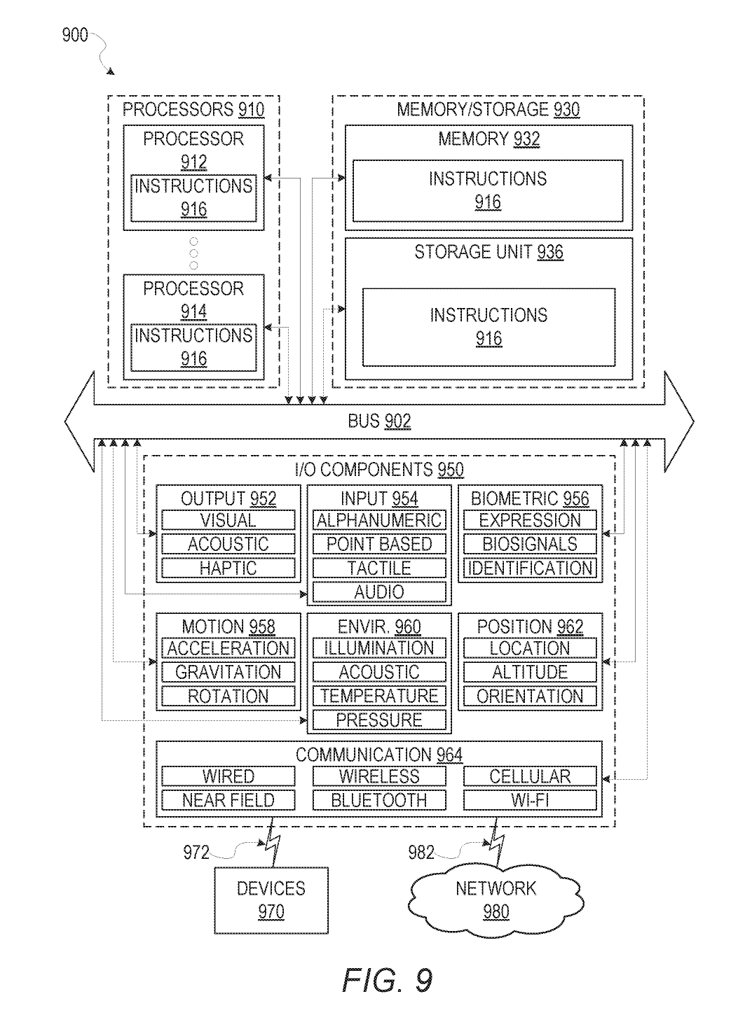

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the interaction diagrams illustrated in FIGS. 5-7 and/or the method illustrated in FIGS. 8A-8B. Additionally, or alternatively, the instructions may implement the sensor data processing module 419, the positioning data processing module 420, the augmented reality display module 422, and the wireless communication module 424 of FIG. 4 and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and PO components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components e.g., a mouse, a touchpad, a trackball, a joystick, a motion sensor, or other pointing instrument), tactile input components e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components e.g., one or more thermometer that detect ambient temperature), humidity sensor components, pressure sensor components (e.g., barometer), acoustic sensor components (e.g., one or more microphones that detect background noise), proximity sensor components infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices a peripheral device coupled via a Universal Serial Bus (USB)).

Moreover, the communication components 964 may detect identifiers or include components operable to detect identifiers. For example, the communication components 964 may include Radio Frequency Identification (REID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A wearable system for acquiring images using different types of imaging sensors, the system comprising:
a machine-readable memory storing computer-executable instructions; and
at least one hardware processor in communication with the machine-readable memory that, when the computer-executable instructions are executed, configures the system to:
obtain first sensor data using a first type of imaging sensor;
determine whether the first sensor data satisfies at least one conditional context selected from a plurality of conditional contexts, the at least one conditional context comprising a condition that is satisfiable by the first sensor data and an outcome indicating an action the at least one hardware processor is to take;
in response to the at least one conditional context being satisfied, engage at least one millimeter wave sensor communicatively coupled to the at least one hardware processor;
obtain second sensor data using the at least one millimeter wave sensor; and
generate an augmented reality image on a display communicatively coupled to the at least one hardware processor, the augmented reality image comprising a millimeter wave image based on the obtained second sensor data.

2. The wearable system of claim 1, wherein the at least one conditional context corresponds to image recognition being performed on the first sensor data.

3. The wearable system of claim 1, wherein the at least one conditional context corresponds to temperature analysis being performed on the first sensor data.

4. The wearable system of claim 1, wherein the at least one hardware processor further configures the system to:
orient the at least one millimeter wave sensor towards an object corresponding to the first sensor data that satisfied the at least one conditional context.

5. The wearable system of claim 1, wherein the at least one hardware processor further configures the system to determine whether a potential threat is present by comparing the second sensor data with organic characteristic data, the organic characteristic data comprising at least one characteristic of an organic object in how it responds to exposure of millimeter wave energy.

6. The wearable system of claim 1, wherein the at least one hardware processor further configures the system to determine whether a potential threat is present by comparing the second sensor data with inorganic characteristic data, the inorganic characteristic data comprising at least one characteristic of an inorganic object in how it responds to exposure of millimeter wave energy

7. The wearable system of claim 6, wherein the augmented reality image further comprises an identification of the potential threat based on the comparison of the second sensor data with the inorganic characteristic data and a location of the potential threat.

8. A method for acquiring images using different types of imaging sensors, the method comprising:
obtaining first sensor data using a first type of imaging sensor;
determining, by at least one hardware processor, whether the first sensor data satisfies at least one conditional context selected from a plurality of conditional contexts, the at least one conditional context comprising a condition that is satisfiable by the first sensor data and an outcome indicating an action the at least one hardware processor is to take;
in response to the at least one conditional context being satisfied, engaging at least one millimeter wave sensor communicatively coupled to the at least one hardware processor;
obtaining second sensor data using the at least one millimeter wave sensor; and
generating, by at least one hardware processor, an augmented reality image on a display communicatively coupled to the at least one hardware processor, the augmented reality image comprising a millimeter wave image based on the obtained second sensor data.

9. The method of claim 8, wherein the at least one conditional context corresponds to image recognition being performed on the first sensor data.

10. The method of claim 8, wherein the at least one conditional context corresponds to temperature analysis being performed on the first sensor data.

11. The method of claim 8, further comprising:
orienting the at least one millimeter wave sensor towards an object corresponding to the first sensor data that satisfied the at least one conditional context.

12. The method of claim 8, further comprising:
determining whether a potential threat is present by comparing the second sensor data with organic characteristic data, the organic characteristic data comprising at least one characteristic of an organic object in how it responds to exposure of millimeter wave energy.

13. The method of claim 8, further comprising:
determining whether a potential threat is present by comparing the second sensor data with inorganic characteristic data, the inorganic characteristic data comprising at least one characteristic of an inorganic object in how it responds to exposure of millimeter wave energy

14. The method of claim 13, wherein the augmented reality image further comprises an identification of the potential threat based on the comparison of the second sensor data with the inorganic characteristic data and a location of the potential threat.

15. A machine-readable medium having computer-executable instructions stored thereon that, when executed by at least one hardware processor, causes the at least one hardware processor to configure a system to perform a plurality of operations, the plurality of operations comprising:
obtaining first sensor data using a first type of imaging sensor;
determining, by at least one hardware processor, whether the first sensor data satisfies at least one conditional context selected from a plurality of conditional contexts, the at least one conditional context comprising a condition that is satisfiable by the first sensor data and an outcome indicating an action the at least one hardware processor is to take;
in response to the at least one conditional context being satisfied, engaging at least one millimeter wave sensor communicatively coupled to the at least one hardware processor;
obtaining second sensor data using the at least one millimeter wave sensor; and
generating, by at least one hardware processor, an augmented reality image on a display communicatively coupled to the at least one hardware processor, the augmented reality image comprising a millimeter wave image based on the obtained second sensor data.

16. The machine-readable medium of claim 15, wherein the at least one conditional context corresponds to image recognition being performed on the first sensor data.

17. The machine-readable medium of claim 15, wherein the at least one conditional context corresponds to temperature analysis being performed on the first sensor data.

18. The machine-readable medium of claim 15, wherein the plurality of operations further comprise:
orienting the at least one millimeter wave sensor towards an object corresponding to the first sensor data that satisfied the at least one conditional context.

19. The machine-readable medium of claim 15, wherein the plurality of operations further comprise:
determining whether a potential threat is present by comparing the second sensor data with inorganic characteristic data, the inorganic characteristic data comprising at least one characteristic of an inorganic object in how it responds to exposure of millimeter wave energy

20. The machine-readable medium of claim 19, wherein the augmented reality image further comprises an identification of the potential threat based on the comparison of the second sensor data with the inorganic characteristic data and a location of the potential threat.
